(19) United States
(12) Patent Application Publication
(10) Pub. No.: US 2012/0263905 A1
(43) Pub. Date: Oct. 18, 2012

(54) ADHESIVE STICKER AND MANUFACTURING METHOD THEREOF

(76) Inventor: Mi-Suk PARK, Anyang-si (KR)

(21) Appl. No.: 13/086,227

(22) Filed: Apr. 13, 2011

(51) Int. Cl. C09J 7/04; B05D 1/36; B05D 5/10; B05D 1/00; B05D 5/00; B05D 5/06

(52) U.S. Cl. 428/41.8; 427/160; 427/162

(57) ABSTRACT

An adhesive sticker and a manufacturing method thereof. The adhesive sticker comprises a paper or PET release sheet on which a figure or pattern is printed, an adhesive layer deposited on the release sheet by a screen printing process in the same shape as the figure or pattern, a non-woven fabric or polymethylmethacrylate (PMMA) layer deposited on the adhesive layer in the same shape as the figure or pattern, base coating layer deposited on the non-woven fabric or polymethylmethacrylate (PMMA) layer, a color printed layer deposited on the base coating layer, a glitter layer attached onto the color printed layer, a first coating layer deposited on the glitter layer, a second coating layer deposited on the first coating layer, and one or more of an ornament(stone) layer, a glitter layer and an epoxy layer, deposited on the second coating layer.

### BACKGROUND OF THE INVENTION

1. Field of the Invention

The present invention relates to an extension hose for a vacuum cleaner, and more particularly, to such an extension hose for a vacuum cleaner, which includes a female connector mounted at one end thereof and a male connector mounted at other end thereof so that a flexible hose of the vacuum cleaner can be extended.

The present invention relates to an adhesive sticker and a manufacturing method thereof, which have the following features and effects: unlike the prior art where a coating layer and a white color layer are formed on an adhesive layer, a non-woven fabric or polymethylmethacrylate (PMMA) layer is formed on a paper or PET release sheet, and thus the number of process steps is reduced by one or two steps, thus making the printing process simple and easy; the non-woven fabric or polymethylmethacrylate layer is deposited on the adhesive layer, formed on the paper or PET release sheet, in the same shape as a figure or pattern, and thus the adhesive of the adhesive layer will not remain on the surface from which the sticker was detached after attachment; a base coating layer is deposited on the non-woven fabric or polymethylmethacrylate (PMMA) layer, and thus the non-woven fabric layer or polymethylmethacrylate (PMMA) layer can be easily printed and the sticker has high surface hardness so that the sticker surface is not easily damaged even when being rubbed with a nail or a coin; the adhesive sticker comprises the non-woven fabric or polymethylmethacrylate (PMMA) layer, and thus it can be used in a wide range of applications, including nail stickers, stationary goods such as ball pens, sharp pens, notebooks and rules, tiles for restroom decoration, accessories for mobile phones, decorations for homes and offices, mirrors, glass, and the like; a color layer is printed on the base coating layer, and thus the sticker can be manufactured in various colors while it allows people to develop their own style suited for their preference in an easy and simple manner; one or more of a glitter, gold foil, silver foil, fragrance, ornament(stone) and epoxy are provided on the color layer, so that the visual appearance of the sticker can be improved; and the non-woven fabric or polymethylmethacrylate (PMMA) layer, which is the adhesive layer is heat-resistant during various post-processes and more elastic than other materials, is deposited on the adhesive layer, and thus the sticker attached to a nail can be prevented from being peeled off or curled up at the end of the nail, unlike the conventional sticker, and can look natural rather than artificial.

2. Background of the Related Art

With the development of the service industry, the nail art industry is developing rapidly. These days, nail care becomes a part of fashion coordination and is being recognized to be necessary for daily life. It becomes popular regardless of age and plays an important role in self-expression by self-satisfaction. Also, with an increasing demand for diversified, individualized and high-quality life, the people's demand to express their own individuality and beauty is increasing, and various nail art materials and design techniques that reflect young's people preference for the new one are being studied. However, in the case of nail art in which nails are manicured, the operation is very troublesome, difficult and time-consuming.

Also, in the case of the nail art, it is not easy for a person to manicure the nails by herself/himself, and thus the nail art is generally done by a nail technician with high expenses. Furthermore, due to frequent hand washing, various patterns or letters printed on the nails are erased within a few days, and thus the effect of the nail art is insufficient in spite of high expenses.

On the other hand, there is a case in which commercially available artificial nails are used. Because the artificial nail is not provided with an adhesive means on the back surface thereof, the artificial nail can be used after applying an adhesive to the back surface of the artificial nail. In this case, there is a problem in that, if the adhesive applied to the back surface of the artificial nail is removed, the back surface of the artificial nail will be dirty so that the artificial nail cannot be reused. Also, during the use of a remover to remove the adhesive applied to the back surface of the artificial nail, skin troubles can occur. To overcome such problems, an adhesive sticker for artificial nails was developed. However, this adhesive sticker has problems in that bubbles occur during the application of the adhesive sticker to the back surface of the artificial nail to significantly reduce the adhesion therebetween and in that the back surface of the artificial nail is contaminated during the removal of the adhesive sticker.

In another method, stickers are attached to nails. However, these stickers generally have a simple planar structure and are manufactured by forming only a printed layer. For this reason, these stickers cannot create beauty, and thus are insufficient for satisfying the various preferences of consumers. Also, in the case in which a coating film and a white color layer are applied to an adhesive layer before printing, there are shortcomings in that, because a plurality of printing processes have to be carried out depending on the colors of patterns, the printing process is complicated and troublesome, and the cost of the product is high.

Therefore, it is urgently required to develop an adhesive sticker and a manufacturing method thereof, which have the following features and effects: a new design technique for manufacturing the adhesive sticker is used so that the number of process steps can be reduced by one or two steps, thus making the printing process simple and easy; the adhesive of an adhesive layer will not remain on the surface from which the sticker was detached after attachment; the sticker has high surface hardness so that the sticker surface is not easily damaged even when being rubbed with a nail or a coin; the adhesive sticker allows people to develop their own style suited for their preference in an easy and simple manner; the visual appearance of the sticker can be improved; and a non-woven fabric or polymethylmethacrylate (PMMA) layer, which is heat-resistant during various post-processes and more elastic than other materials, is deposited on the adhesive layer, and thus the inventive sticker attached to a nail can be prevented from being peeled off or curled up at the end of the nail, unlike the conventional sticker, and can look natural rather than artificial.

### SUMMARY OF THE INVENTION

Accordingly, the present invention has been made in order to solve the above-described problems occurring in the prior art, and it is an object of the present invention to provide an adhesive sticker and a manufacturing method thereof, in which, unlike the prior art where a coating film and a white color layer are formed on an adhesive layer, a non-woven fabric or polymethylmethacrylate (PMMA) layer is formed on an adhesive layer formed on a paper or PET release sheet, and thus the number of process steps can be reduced by one or two steps, thus making the printing process simple and easy.

Another object of the present invention is to provide an adhesive sticker and a manufacturing method thereof, in which a non-woven fabric or polymethylmethacrylate (PMMA) layer is deposited on an adhesive layer on a paper or PET release sheet in the same shape as a figure or pattern without spots, and thus the adhesive of the sticker will not remain on the surface from which the sticker was detached after attachment.

Still another object of the present invention is to provide an adhesive sticker and a manufacturing method thereof, in which a base coating layer is deposited on a non-woven fabric layer or a polymethylmethacrylate (PMMA) layer, and thus the non-woven fabric layer can be easily printed and the sticker has high surface hardness so that the sticker surface is easily not damaged even when being rubbed with a nail or a coin.

Yet another object of the present invention is to provide an adhesive sticker and a manufacturing method thereof, in which the adhesive sticker comprises a non-woven fabric or polymethylmethacylate layer, and thus the adhesive sticker can be used in a wide range of applications, including nail stickers, stationary goods such as ball pens, sharp pens, notebooks and rules, tiles for restroom decoration, accessories for mobile phones, decorations for homes and offices, mirrors, glass, and the like.

A further object of the present invention is to provide an adhesive sticker and a manufacturing method thereof, in which a color layer is printed on a base coating layer, and thus the sticker can be manufactured in various colors while it allows people to develop their own style suited for their preference in an easy and simple manner.

A still further object of the present invention is to provide an adhesive sticker and a manufacturing method thereof, in which one or more of gold foil, silver foil, a glitter, fragrance, an ornament(stone) and epoxy resin are provided on a color layer, and thus the visual appearance of the sticker can be improved.

Another further object of the present invention is to provide an adhesive sticker and a manufacturing method thereof, in which a non-woven fabric or polymethylmethacrylate (PMMA) layer, which is heat-resistant during various post-processes and more elastic than other materials, is deposited on an adhesive layer, and thus the sticker attached to a nail can be prevented from being peeled off or curled up at the end of the nail, unlike the conventional sticker, and can look natural rather than artificial.

To achieve the above objects, in accordance with a preferred embodiment of the present invention, there is provided an adhesive sticker including: a paper or PET release sheet on which a figure or pattern is printed by an offset printing, gravure printing, digital printing or screen printing process; an adhesive layer made of a resin or acrylic material, which has the same shape as said figure or pattern and is deposited on the paper or PET release sheet by a screen printing process so that the release sheet can be detached; a non-woven fabric or polymethylmethacrylate (PMMA) layer which is deposited on the adhesive layer in the same shape as said figure or pattern by a screen printing process; a base coating layer which is deposited on the non-woven fabric or polymethylmethacrylate (PMMA) layer by an offset printing, gravure printing, digital printing or screen printing process, the base coating layer being made of any one of a urethane coating, an acrylic coating, a UV coating, a PVC-sol coating and a polyurethane coating; a color printed layer which is deposited on the base coating layer by coating ink on the base coating layer using a screen printing process, the base coating layer being made of any one of a UV coating, a urethane coating, a PVC-sol coating, a silicone coating and an acrylic coating and serving to impart various colors; a glitter layer which is attached onto the color printed layer in a solid form by a screen printing process or is applied to the color printed layer in a loose form or dispersed on the color printed layer in a liquid form, the glitter layer serving to improve the visual appearance of the sticker and impart softness; a first coating layer which is deposited on the glitter layer by a screen printing process, the first coating layer being made of any one or more of PU, urethane-based resin, acrylic resin, UV resin and silicone resin; a second coating layer which is deposited on the first coating layer by a screen printing process, the second coating layer being made of any one or more of PU, ethyl acetate, oily or aqueous urethane, and rubber-based acrylic resin; and one or more of an ornament(stone) layer, a glitter layer and an epoxy layer, which are deposited on the second coating layer by a screen printing process.

In the present invention, the non-woven fabric or polymethylmethacrylate (PMMA) layer deposited on the adhesive layer is heat-resistant during various post-processes and more elastic, and thus the sticker attached to a nail can be prevented from being peeled off or curled up at the end of the nail, unlike other conventional stickers, and can look natural rather than artificial.

In the present invention, the adhesive layer preferably includes a plasticizer and at least one selected from among a

UV adhesive, a silicone adhesive, a urethane adhesive and an acrylic adhesive and serves to improve adhesion.

In the present invention, the glitter layer preferably further includes one or more of a gold foil layer and a silver foil layer to improve the visual appearance of the sticker.

In accordance with another preferred embodiment of the present invention, there is provided a method for manufacturing an adhesive sticker, the method including the steps of: forming on a paper or PET release sheet an adhesive layer made of a resin or acrylic material in the same shape as a figure or pattern, which is to be printed, by a screen printing process, so that the release sheet can be detached; depositing a non-woven fabric or polymethylmethacrylate (PMMA) layer on the adhesive layer in the same shape as said figure or pattern by an offset printing, gravure printing, digital printing or screen printing process; depositing a base coating layer on the non-woven fabric or polymethylmethacrylate (PMMA) layer by a screen printing process, the base coating layer being made of any one of a urethane coating, an acrylic coating, a UV coating, a polyurethane coating and a silicone coating; depositing a color printed layer on the base coating layer by coating ink on the base coating layer using an offset printing, gravure printing, digital printing or screen printing process, the base coating layer being made of any one of a UV coating, a urethane coating and a PVC-sol coating and serving to impart various colors; attaching a glitter layer onto the color printed layer in a solid form by a screen printing process, or applying the glitter layer to the color printed layer in a loose form, or dispersing the glitter layer on the color printed layer in a liquid form, the glitter layer serving to improve the visual appearance of the sticker and impart softness; depositing a first coating layer on the glitter layer by a screen printing process, the first coating layer being made of any one or more of PU resin, urethane-based resin, acrylic resin, UV resin and silicone resin; depositing a second coating layer on the first coating layer by a screen printing process, the second coating layer being made of any one or more of PU resin, ethyl acetate, oily or aqueous urethane, and rubber-based acrylic resin; and forming on the second coating layer one or more of an ornament(stone) layer, a glitter layer and an epoxy layer by a screen printing process.

In the present invention, the step of depositing the non-woven fabric is preferably replaced by a step of depositing a polymethylmethacrylate (PMMA) layer, which is heat-resistant during various post-processes and more elastic so that the sticker attached to a nail can be prevented from being peeled off or curled up at the end of the nail, unlike other conventional stickers, and can look natural rather than artificial.

In the present invention, the step of forming the glitter layer preferably further includes adding one or more of a gold foil layer and a silver foil layer to the glitter layer so as to improve the visual appearance of the sticker.

In the present invention, the step of forming the adhesive layer preferably further includes treating the surface of the release sheet so as to increase the release force of the release sheet.

In the present invention, the step of depositing the color printed layer preferably further includes adding one or more of various letters, figures and patterns so as to improve the visual appearance of the sticker.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 shows the structure of an adhesive sticker according to one embodiment of the present invention; and

FIG. 2 is a flowchart showing a method for manufacturing a nail sticker according to one embodiment of the present invention.

### DETAILED DESCRIPTION OF THE PREFERRED EMBODIMENTS

Now, a preferred embodiment of the present invention will be described hereinafter in more detail with reference to the accompanying drawings.

Hereinafter, a preferred embodiment of the present invention will be described with reference to the accompanying drawings. In the following description, the detailed description of known related functions or constitutions will be omitted so as not to unnecessarily obscure the subject matter of the present invention. The terms used in the description are defined considering the functions in the present invention and may vary depending on the intention or usual practice of a user or operator. Therefore, the definitions of the terms should be made based on the entire contents of the specification describing the nail sticker of the present invention and the manufacturing method thereof.

Hereinafter, the structure of a nail sticker according to a preferred embodiment of the present invention will be described in detail with reference to the accompanying drawings.

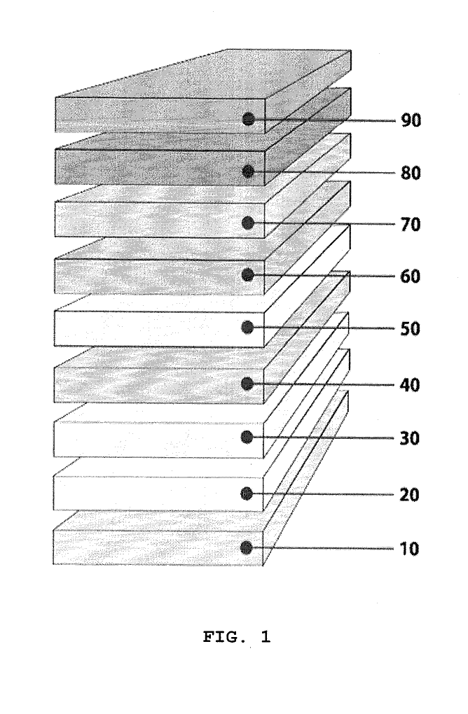

FIG. 1 shows the structure of an adhesive sticker according to one embodiment of the present invention.

As shown in FIG. 1, the structure of an adhesive sticker according to one embodiment of the present invention includes: a paper or PET release sheet 10 on which a figure or pattern is printed by a screen printing process; an adhesive layer 20 made of a resin material (e.g., urethane resin, UV resin, or silicone resin), which has the same shape as said figure or pattern and is deposited on the paper or PET release sheet by an offset printing, gravure printing, digital printing or screen printing process so that the release sheet can be detached; a non-woven fabric or polymethylmethacrylate (PMMA) layer 30 which is deposited on the adhesive layer in the same shape as said figure or pattern by a screen printing process; a base coating layer 40 which is deposited on the non-woven fabric or polymethylmethacrylate (PMMA) layer by a screen printing process, the base coating layer being made of any one of a urethane coating, an acrylic coating, a UV coating, a PVC-sol coating and a polyurethane coating; a color printed layer 50 which is deposited on the base coating layer by coating ink on the base coating layer using an offset printing, gravure printing, digital printing or screen printing process, the base coating layer being made of any one of a UV coating, a urethane coating, a PVC-sol coating, a silicone coating and an acrylic coating and serving to impart various colors; a glitter layer 60 which is attached onto the color printed layer in a solid form by a screen printing process or is applied to the color printed layer in a loose form or dispersed on the color printed layer in a liquid form, the glitter layer serving to improve the visual appearance of the sticker and impart softness; a first coating layer 70 which is deposited on the glitter layer by a screen printing process, the first coating layer being made of any one or more of PU, urethane-based resin, acrylic resin, UV resin and silicone resin; a second coating layer 70 which is deposited on the first coating layer by a screen printing process, the second coating layer being made of any one or more of PU, ethyl acetate, oily or aqueous urethane, and rubber-based acrylic resin; and one or more of an ornament(stone) layer 90, a glitter layer 90 and an epoxy layer 90, which are deposited on the second coating layer by a screen printing process.

The functions of technical means constituting the nail sticker will now be explained.

The paper or PET release sheet 10 is a sheet on which a figure or pattern is printed by a screen printing process. In this regard, the release sheet is any one selected from among vellum paper, art paper, snow white paper, CCP paper, and PET paper.

The adhesive layer 20 is made of a resin or acrylic material, has the same shape as said figure or pattern, and is deposited on the paper or PET release sheet by a screen printing process so that the release sheet can be detached.

The non-woven fabric or polymethylmethacrylate (PMMA) 30 is deposited on the adhesive layer in the same shape as said figure or pattern by an offset printing, gravure printing, digital printing or screen printing process. In this regard, because the non-woven fabric or polymethylmethacrylate (PMMA) layer is deposited on the adhesive layer on the paper or PET release sheet in the same shape as said figure or pattern, the adhesive will not remain on the surface from which the sticker was detached after attachment. Herein, because the non-woven fabric or polymethylmethacrylate (PMMA) layer 30, which is heat-resistant during various processes and more elastic than other materials, is deposited on the adhesive layer 20, the inventive sticker attached to a nail can be prevented from being peeled off or curled up at the end of the nail, unlike the conventional sticker, and can look natural rather than artificial.

The base coating layer 40 is formed on the non-woven fabric or polymethylmethacrylate (PMMA) layer 30 by depositing any one of a urethane coating, an acrylic coating, an UV coating, a PVC-sol coating, a polyurethane (PU) coating and a silicone coating. The base coating layer 40 may be made of a thermoplastic resin, a thermosetting resin or a mixture thereof. The thermoplastic resin becomes soft and plastic upon heating, and examples thereof include polyethylene, polypropylene, PVC, PVC-sol, PVDC, PVA, PS, PET, polycarbonate, cellulose acetate, polyamide, and polyimide. The thermoplastic resin becomes hard and insoluble upon heating, and examples thereof include phenol resin, urea resin, melamine resin, and unsaturated polyester resin.

The color printed layer 50 is formed by depositing any one of an UV coating, a urethane coating, an acrylic coating, a PVC coating and a silicone coating on the base coating layer by an offset printing, gravure printing, digital printing or screen printing process and imparts various colors. Fragrance may be added to the color printed layer 50.

The glitter layer 60 is attached to the color printed layer in the form of a solid material by a screen printing process, or applied to the color printed layer in a loose form or dispersed on the color printed layer in a liquid form, so that it improves the visual appearance of the adhesive sticker and imparts softness. In this regard, the glitter is a material that is attached to a solid material or can be used in a loose form (i.e., a flowable form) or dispersed in a liquid. The glitter is attached to the surface of the sticker or embedded in the sticker so as to improve the visual appearance of the sticker. Also, it may be dispersed in a liquid to provide a visual effect or to improve the appearance of coating materials (e.g., paint, glue and nail manicure). In addition, one or more of a gold foil layer and a silver foil layer may also be added to the glitter layer 60 in order to improve the visual appearance of the sticker.

The first coating layer 70 serves as a coating layer for protecting the gold/silver foil and is formed by coating any one or more of a PU resin, a urethane-based resin, an acrylic resin, a UV resin and a silicone resin on the glitter layer using a screen coating process.

The second coating layer 80 is formed by coating any one of PU, ethyl acetate, oily or aqueous urethane, and rubber-based acrylic resin on the first coating layer using a screen coating process. The second coating layer 80 serves as a protective coating layer that prevents the sticker surface being wrinkled when manicured and that prevents the manicure from easily peeling off. Ethyl acetate and fragrance may be added to the second coating layer 80.

The ornament(stone) layer 90 is deposited on the second coating layer by a screen printing process. The ornament(stone) layer 90 may be deposited along with an epoxy layer and a glitter layer. Also, any one of the ornament layer 90, the epoxy layer and the glitter layer may be deposited.

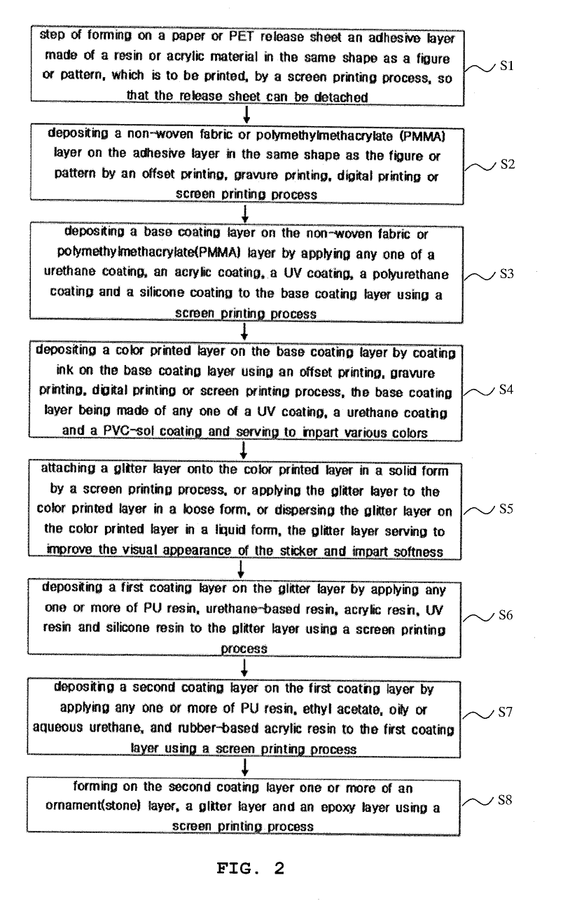

FIG. 2 is a flow chart showing a method for manufacturing an adhesive sticker according to one embodiment of the present invention.

Each step of the method for manufacturing the adhesive sticker according to one embodiment of the present invention will now be described with reference to FIG. 2.

First, step S1 is a step of forming an adhesive layer on a paper or PET release sheet. In this step, an adhesive layer 20 made of a resin, an acrylic resin or a silicone resin is deposited on a paper or PET release sheet 10 in the same shape as a figure or pattern, which is to be printed, by a screen printing process, in such a manner that the release sheet can be detached. The step of forming the adhesive layer 20 may further include treating the release sheet with fluorine or silicon so as to increase the release force of the release sheet.

The next step S2 is a step of depositing a non-woven fabric layer on the adhesive layer. In this step, a non-woven fabric layer 30 is deposited on the adhesive layer 30 in the same shape as said figure or pattern by a screen printing process. The step of depositing the non-woven fabric layer 30 may be replaced by a step of forming a polymethylmethacrylate (PMMA) layer 30. The PMMA layer 30 is heat-resistant during various post-processes and more elastic than other materials, and thus the adhesive sticker attached to a nail can be prevented from being peeled off or curled up at the end of the nail, unlike the conventional sticker, and can look natural rather than artificial.

The next step S3 is a step of depositing a base coating layer. In this step, a base coating layer 40 made of any one selected from a urethane coating, an acrylic coating, an UV coating, a PVC-sol coating and a polyurethane (PU) coating is deposited on the non-woven fabric layer 30 by a screen printing process.

The next step S4 is a step of depositing a color printed layer. In this step, a color printed layer 50 made of any one selected from among a UV coating, a urethane coating and a PVC-sol coating is formed by depositing ink on the base coating layer 40 using an offset printing, gravure printing, digital printing or screen printing process in order to impart various colors. The step of depositing the color printed layer 50 may further include adding one or more of various letters, figures and patterns in order to improve the visual appearance of the sticker.

The next step S5 is a step of forming a glitter layer. In this step, a glitter layer 60 is attached to the color printed layer 50 in the form of a solid material by a screen printing process or applied to the color printed layer in a loose form or dispersed on the color printed layer in a liquid form in order to improve the visual appearance of the sticker and to impart softness. In the step of forming the glitter layer, one or more of the glitter layer 60, a gold foil layer and a silver foil layer are formed in order to improve the appearance of the sticker.

The next step S6 is a step of forming a first coating layer 70. In this step, the first coating layer made of any one selected from among a PU resin, a urethane-based resin, an acrylic resin, a UV resin and a silicone resin is formed on the glitter layer. The first coating layer 70 serves to protect the gold or silver foil.

The next step S7 is a step of forming a second coating layer 80. In this step, the second coating layer 80 made of any one or more selected from among PU, ethyl acetate, oily urethane and rubber-based acrylic resin is formed on the first coating layer. The second coating layer 80 serves as a protective coating layer that prevents the sticker surface being wrinkled when manicured and that prevents the manicure from easily peeling off. Ethyl acetate and fragrance may be added to the second coating layer 80.

The next step S8 is a step of forming an ornament layer 90 on the second coating layer by a screen printing process. In this step, the ornament layer 90 may be deposited along with an epoxy layer. Also, any one selected from the ornament layer 90, the epoxy layer and a glitter layer may be deposited.

The adhesive sticker according to the present invention and the manufacturing method thereof show the following effects.

First, unlike the prior art where a coating layer and a white color layer are formed on the adhesive layer formed on an adhesive layer, because the non-woven fabric layer or polymethylmethacrylate (PMMA) layer is formed on the paper or PET release sheet, the number of process steps is reduced by one or two steps, thus making the printing process simple and easy.

Second, according to the present invention, because the non-woven fabric layer or polymethylmethacrylate layer is deposited on the adhesive layer, formed on the paper or PET release sheet, in the same shape as a figure or pattern to be printed, the adhesive of the adhesive layer will not remain on the surface from which the sticker was detached after attachment.

Third, according to the present invention, because the base coating layer is deposited on the non-woven fabric layer or polymethylmethacrylate (PMMA) layer, the non-woven fabric layer or polymethylmethacrylate (PMMA) layer can be easily printed and the sticker has high surface hardness so that the sticker surface is not damaged when being rubbed with a nail or a coin.

Fourth, according to the present invention, because the adhesive sticker includes the non-woven fabric or polymethylmethacrylate (PMMA) layer, it can be used in a wide range of applications, including nail stickers, stationary goods such as ball pens, sharp pens, notebooks and rules, tiles for restroom decoration, accessories for mobile phones, decorations for homes and offices, mirrors, glass, and the like.

Fifth, according to the present invention, because the color layer is printed on the base coating layer, the sticker can be manufactured in various colors while it allows people to develop their own style suited for their preference in an easy and simple manner.

Sixth, according to the present invention, because one or more of a glitter, gold foil, silver foil, fragrance, ornament(stone) and epoxy are formed on the color layer, the visual appearance of the sticker is improved.

Seventh, according to the present invention, because the non-woven fabric or polymethylmethacrylate (PMMA) layer, which is heat-resistant during various post-processes and more elastic than other materials, is deposited on the adhesive layer, the inventive sticker attached to a nail can be prevented from being peeled off or curled up at the end of the nail, unlike the conventional sticker, and can look natural rather than artificial.

As described above, the adhesive sticker according to the present invention can be used in a wide range of applications, including nail stickers, stationary goods such as ball pens, sharp pens, notebooks and rules, tiles for restroom decoration, accessories for mobile phones, decorations for homes and offices, mirrors, glass, and the like.

Although the present invention has been described in connection with the preferred embodiments thereof, they are mere examples of the present invention. It will be understood by a person skilled in the art various modifications, changes and equivalents thereof can be made thereto within the spirit of the present invention. Therefore, the true scope of the present invention should be defined by the appended claims.

What is claimed is:

1. An adhesive sticker comprising:
a paper or PET release sheet on which a figure or pattern is printed by an offset printing, gravure printing, digital printing or screen printing process;
an adhesive layer made of a resin or acrylic material, which has the same shape as said figure or pattern and is deposited on the paper or PET release sheet by a screen printing process so that the release sheet can be detached;
a non-woven fabric or polymethylmethacrylate (PMMA) layer which is deposited on the adhesive layer in the same shape as said figure or pattern by a screen printing process;
a base coating layer which is deposited on the non-woven fabric or polymethylmethacrylate (PMMA) layer by an offset printing, gravure printing, digital printing or screen printing process, the base coating layer being made of any one of a urethane coating, an acrylic coating, a UV coating, a PVC-sol coating and a polyurethane coating;
a color printed layer which is deposited on the base coating layer by coating ink on the base coating layer using a screen printing process, the base coating layer being made of any one of a UV coating, a urethane coating, a PVC-sol coating, a silicone coating and an acrylic coating and serving to impart various colors;
a glitter layer which is attached onto the color printed layer in a solid form by a screen printing process or is applied to the color printed layer in a loose form or dispersed on the color printed layer in a liquid form, the glitter layer serving to improve the visual appearance of the sticker and impart softness;
a first coating layer which is deposited on the glitter layer by a screen printing process, the first coating layer being made of any one or more of PU, urethane-based resin, acrylic resin, UV resin and silicone resin;
a second coating layer which is deposited on the first coating layer by a screen printing process, the second coating layer being made of any one or more of PU, ethyl acetate, oily or aqueous urethane, and rubber-based acrylic resin; and
one or more of an ornament(stone) layer, a glitter layer and an epoxy layer, which are deposited on the second coating layer by a screen printing process.

2. The adhesive sticker according to claim 1, wherein the non-woven fabric or polymethylmethacrylate (PMMA) layer deposited on the adhesive layer is heat-resistant during various post-processes and more elastic, and thus the sticker attached to a nail can be prevented from being peeled off or curled up at the end of the nail, unlike other conventional stickers, and can look natural rather than artificial.

3. The adhesive sticker according to claim 1, wherein the adhesive layer comprises a plasticizer and at least one selected from among a UV adhesive, a silicone adhesive, a urethane adhesive and an acrylic adhesive and serves to improve adhesion.

4. The adhesive sticker according to claim 1, wherein the glitter layer further comprises one or more of a gold foil layer and a silver foil layer to improve the visual appearance of the sticker.

5. A method for manufacturing an adhesive sticker, the method comprising the steps of:
forming on a paper or PET release sheet an adhesive layer made of a resin or acrylic material in the same shape as a figure or pattern, which is to be printed, by a screen printing process, so that the release sheet can be detached;
depositing a non-woven fabric or polymethylmethacrylate (PMMA) layer on the adhesive layer in the same shape as said figure or pattern by an offset printing, gravure printing, digital printing or screen printing process;
depositing a base coating layer on the non-woven fabric or polymethylmethacrylate (PMMA) layer by a screen printing process, the base coating layer being made of any one of a urethane coating, an acrylic coating, a UV coating, a polyurethane coating and a silicone coating;
depositing a color printed layer on the base coating layer by coating ink on the base coating layer using an offset printing, gravure printing, digital printing or screen printing process, the base coating layer being made of any one of a UV coating, a urethane coating and a PVC-sol coating and serving to impart various colors;
attaching a glitter layer onto the color printed layer in a solid form by a screen printing process, or applying the glitter layer to the color printed layer in a loose form, or dispersing the glitter layer on the color printed layer in a liquid form, the glitter layer serving to improve the visual appearance of the sticker and impart softness;
depositing a first coating layer on the glitter layer by a screen printing process, the first coating layer being made of any one or more of PU resin, urethane-based resin, acrylic resin, UV resin and silicone resin;
depositing a second coating layer on the first coating layer by a screen printing process, the second coating layer being made of any one or more of PU resin, ethyl acetate, oily or aqueous urethane, and rubber-based acrylic resin; and
forming on the second coating layer one or more of an ornament(stone) layer, a glitter layer and an epoxy layer by a screen printing process.

6. The method according to claim 5, wherein the step of depositing the non-woven fabric is replaced by a step of depositing a polymethylmethacrylate (PMMA) layer, which is heat-resistant during various post-processes and more elastic so that the sticker attached to a nail can be prevented from being peeled off or curled up at the end of the nail, unlike other conventional stickers, and can look natural rather than artificial.

7. The method according to claim 5, wherein the step of forming the glitter layer further comprises adding one or more of a gold foil layer and a silver foil layer to the glitter layer so as to improve the visual appearance of the sticker.

8. The method according to claim 5, wherein the step of forming the adhesive layer further comprises treating the surface of the release sheet so as to increase the release force of the release sheet.

9. The method according to claim 5, wherein the step of depositing the color printed layer further comprises adding one or more of various letters, figures and patterns so as to improve the visual appearance of the sticker.
